(19) United States
(12) Patent Application Publication
(10) Pub. No.: US 2001/0024670 A1
(43) Pub. Date: Sep. 27, 2001

(54) Novelty cookie product

(76) Inventors: Robert F. Gehan, Morristown, NJ (US); Zeinab M. Ali, Morristown, NJ (US)

Correspondence Address: Ware, Fressola, Van Der Sluys & Adolphson LLP, Bradford Green, Bldg. Five, 755 Main Street, P.O. Box 224, Monroe, CT, 06468, US

(21) Appl. No.: 09/761,322

(22) Filed: Jan. 16, 2001

Related U.S. Application Data
(60) Provisional application No. 60/176,431, filed on Jan. 14, 2000.

(51) Int. Cl. A23L 1/48

(52) U.S. Cl. 426/87; 426/104

(57) ABSTRACT

A cookie product has entertainment value and interest in addition to its good taste and satisfying snack value. The cookie product comprises a base cake having an image thereon and a layer of confection covering at least a portion of the image. Preferably, the cookie is a sandwich cookie having two base cakes separated by and adhered with a confection filling. In its preferred form, the image comprises a depiction of a cartoon character appearing on a television screen and a second base cake has an image of a television with an unclear picture that is visible when the cookie is taken from its package or container. A method of making the cookie product and a method of eating it are also provided.

### BACKGROUND OF THE INVENTION

The invention relates to a cookie product that has entertainment value and interest in addition to its good taste and satisfying snack value.

Sandwich coolies are well known and are available commercially under a number of brand names including OREO®, NUTTER BUTTER®, SNACKWELL'S® and many others. Basically, these cookies comprise two base cakes adhered by a creamed frosting filling. Many consumers especially enjoy breaking the cookies apart to expose the filling and then eating the filling by itself. Once the filling is removed, the base cakes are then eaten as plain cookies.

Thus, like all cookies, the typical sandwich cookie is primarily for the purpose of providing a satisfying a sweet tooth and the desire for a snack—not the provision of entertainment. Efforts have been made with familiar images on one or more surfaces on the outside of cookies to provide some additional interest to the eating experience. For example, cookies are known having intaglio or relief as by line drawing or three-dimensional figures. Cookies are also known to be made with printed matter on a surface, as in U.S. Pat. Nos. 4,578,273 and 5,534,281.

What is missing in the art is some type of imaging utilized on or with a cookie to provide an extra dimension of interest and entertainment to the eating experience.

### SUMMARY OF THE INVENTION

Accordingly, it is an object of the present invention to provide a novelty cookie product that is produced easily by conventional cookie forming equipment but provides an added level of enjoyment for the consumer.

It is a more specific object in this regard to a sandwich cookie having a familiar and interesting graphics associated with it.

Still another object of the invention is to provide a sandwich cookie having graphics associated with it that are revealed during the eating experience.

A more specific aspect of the invention to make cookie eating more fun.

These and other objectives are achieved by the invention, which provides a novelty cookie product, a method of making it and a method of eating it. The cookie product comprises a base cake having an image thereon and a layer of confection covering at least a portion of the image. Preferably, the cookie is a sandwich cookie having two base cakes separated by and adhered with a confection filling.

Many preferred aspects of the invention are described below. The invention and its particular features will become more apparent from the following detailed description considered with reference to the accompanying drawings.

### BRIEF DESCRIPTION OF THE DRAWINGS

FIG. 1 is a perspective view of a sandwich cookie according to one embodiment of the invention.

FIG. 2 is a cross sectional view taken along line 2-2 in FIG. 1.

FIG. 3 is front elevation of a bottom biscuit portion of the sandwich cookie shown in FIG. 1.

FIG. 4 is cross sectional view taken along line 4-4 in FIG. 3.

### DETAILED DESCRIPTION OF THE INVENTION

The following description will detail preferred embodiments of the invention, to best show several preferred aspects.

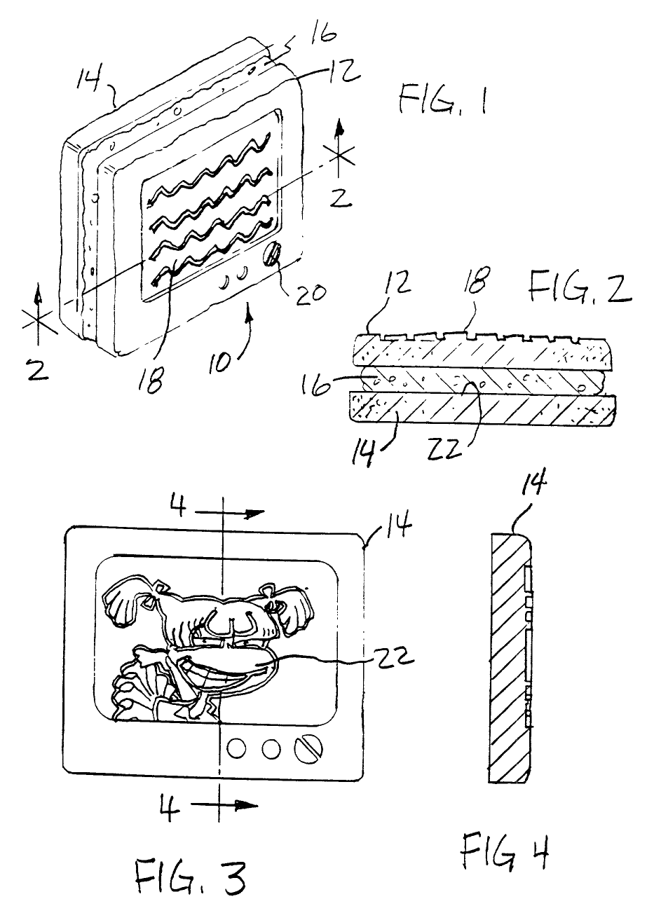

The invention provides a novelty cookie product which adds a dimension of entertainment to the already enjoyable experience of eating a sandwich cookie. The product is believed to have special appeal to children, but has prompted behavior in adults similar to that of children. The preferred form of the cookie 10, shown in FIG. 1, has a front or top cake 12 having a representation of a television 18, including dial 20, on the outside surface with no clear picture on the screen. Inside, the cookie has a confection filling 16 and is backed by another cake 14. The cake 14 has a suitable image 22, which when used in combination with the confection filling 16, presents a latent image that can be revealed by eating in the manner of the invention—namely, removing at least sufficient of the confection to at least partially remove the confection. To the children eating them this is a distinct pleasure—here is a cookie product specially made for them to split open and lick off the confection filling so that they can see the picture.

FIG. 2 shows a cross section of the cookie of FIG. 1, taken along line 2-2. It will be seen that in this embodiment, cake 12 has an intaglio image 18 and cake 14 has an intaglio image 22. The image can be a relief or other three-dimensional or two-dimensional image. FIG. 3 illustrates one preferred form of the invention wherein a popular cartoon figure as it might appear when viewed on a television screen (Angelica of Rugrat fame) forms the image. Preferably, the image will be one that is easily recognized by children and will provide them with a point of visual interest when the confection is removed.

The confection is preferably a sandwich cream of the typical variety comprised of fat and sugar as described, for example, in “Biscuits, Crackers & Cookies Volume 1” by W. H. Smith, Magazines For Industry, Inc., copyright 1972 by Applied Science Publishers Ltd., e.g., pages 314-335. The base cakes are also of conventional formulation and are preferably formed by conventional rotary molding procedures. The disclosures of the above-noted text and the patents listed above are hereby incorporated by reference for their disclosures of formulations, processing techniques and suitable packaging.

The above description is for the purpose of teaching the person of ordinary skill in the art how to practice the present invention, and it is not intended to detail all of those obvious modifications and variations of it which will become apparent to the skilled worker upon reading this description. It is intended, however, that all such obvious modifications and variations be included within the scope of the present invention which is defined by the following claims. The claims cover the indicated components and steps in all arrangements and sequences which are effective to meet the objectives intended for the invention, unless the context specifically indicates the contrary.

What is claimed is:

1. A novelty cookie product comprising a base cake having an image thereon and a layer of confection covering at least a portion of the image.

2. A cookie product according to claim 1 wherein the cookie product is a sandwich cookie having two base cakes separated by and adhered with a confection filling.

3. A cookie product according to claim 1 wherein the image on the base cake is three-dimensional.

4. A cookie product according to claim 1 wherein the image on the base cake is formed by rotary molding to have a pattern of lands and recesses such that the confection, when partially removed at least partially fills in the recesses.

5. A cookie product according to claim 1 wherein the confection is a sandwich cream comprised of fat and sugar.

6. A cookie product according to claim 1 wherein the image comprises a depiction of a cartoon character appearing on a television screen.

7. A cookie product according to claim 1 wherein the image comprises a depiction of a cartoon character appearing on a television screen, the confection is a sandwich cream comprised of fat and sugar and the confection is covered by a second base cake.

8. A method of making a novelty cookie product comprising baking a base cake having an image thereon and applying thereto a layer of confection to cover at least a portion of the image.

9. A method of making a novelty cookie product according to claim 8 which includes covering the confection with a second base cake to form a sandwich cookie.

10. A method of making a novelty cookie product according to claim 8 wherein the base cakes are formed by rotary molding to create three-dimensional images therein.

11. A method of making a novelty cookie product according to claim 8 wherein the confection is a sandwich cream comprised of fat and sugar.

12. A method of making a novelty cookie product according to claim 8 wherein the image comprises a depiction of a cartoon character appearing on a television screen.

13. A method of eating a novelty cookie product comprising obtaining a cookie product as defined in claim 1 and removing a sufficient amount of the confection to reveal the image.
